(19) United States
(12) Patent Application Publication
(10) Pub. No.: US 2020/0091493 A1
(43) Pub. Date: Mar. 19, 2020

(54) BATTERY MODULE INCLUDING COATED OR CLAD MATERIAL CONTACT PLATE

(71) Applicant: Tiveni MergeCo, Inc., San Mateo, CA (US)

(72) Inventors: Heiner FEES, Bietigheim-Bissingen (DE); Andreas TRACK, Sachsenheim (DE); Ralf MAISCH, Abstatt (DE); Alexander EICHHORN, Eppingen (DE); Jörg DAMASKE, Freiberg (DE); Valentin BROKOP, Walheim (DE); Hans-Joachim PFLÜGER, Wüstenrot (DE); Claus Gerald PFLÜGER, Markgröningen (DE)

(21) Appl. No.: 16/575,007

(22) Filed: Sep. 18, 2019

Related U.S. Application Data
(60) Provisional application No. 62/733,194, filed on Sep. 19, 2018.

(51) Int. Cl. H01M 2/30; H01M 2/20; H01M 2/22; H01M 2/34

(52) U.S. Cl. CPC H01M 2/305; H01M 2/206; H01M 2220/00; H01M 2/348; H01M 2200/103; H01M 2/22

(57) ABSTRACT

An embodiment of the disclosure is directed to a battery module, comprising a plurality of battery cells that each include a cell terminal formed from a first metal, and a contact plate including a conductive plate that is formed from a second metal and a first metallic surface layer (e.g., a surface coating or clad material) arranged on a first side of the conductive plate that is formed from the first metal, wherein part of the contact plate is arranged as a plurality of bonding connectors that form direct electrical connections to the cell terminals of the plurality of battery cells. In some designs, a second metallic surface layer (e.g., a surface coating or clad material) may further be arranged on a second side of the conductive plate and may also be formed from the first metal.

### CROSS-REFERENCE TO RELATED APPLICATIONS

The present Application for Patent claims the benefit of U.S. Provisional Application No. 62/733,194 with attorney docket no. TIV-180008P1, entitled “BATTERY MODULE INCLUDING COATED OR CLAD MATERIAL CONTACT PLATE”, filed Sep. 19, 2018, which is assigned to the assignee hereof and hereby expressly incorporated by reference herein in its entirety.

### BACKGROUND

### 1. Field of the Disclosure

Embodiments relate to a battery module comprising a coated or cladded contact plate.

### 2. Description of the Related Art

Energy storage systems may rely upon battery cells for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

### SUMMARY

An embodiment of the disclosure is directed to a battery module, comprising a plurality of battery cells that each include a cell terminal formed from a first metal, and a contact plate including a conductive plate that is formed from a second metal and a first metallic surface layer (e.g., a surface coating or clad material) arranged on a first side of the conductive plate that is formed from the first metal, wherein part of the contact plate is arranged as a plurality of bonding connectors that form direct electrical connections to the cell terminals of the plurality of battery cells. In some designs, a second metallic surface layer (e.g., a surface coating or clad material) may further be arranged on a second side of the conductive plate and may also be formed from the first metal.

Another embodiment of the disclosure is directed to battery module, comprising a plurality of battery cells that each include a cell terminal formed from a first metal, and a contact plate including a conductive plate that is formed from a second metal, a first metallic surface layer arranged on a first side of the conductive plate that is formed from the first metal, and a second metallic surface layer arranged on a second side of the conductive plate, wherein part of the contact plate is arranged as a plurality of bonding connectors that form direct electrical connections to the cell terminals of the plurality of battery cells.

### BRIEF DESCRIPTION OF THE DRAWINGS

A more complete appreciation of embodiments of the disclosure will be readily obtained as the same becomes better understood by reference to the following detailed description when considered in connection with the accompanying drawings, which are presented solely for illustration and not limitation of the disclosure, and in which:

FIG. 1 illustrates an example metal-ion (e.g., Li-ion) battery in which the components, materials, methods, and other techniques described herein, or combinations thereof, may be applied according to various embodiments.

FIG. 2 illustrates a high-level electrical diagram of a battery module that shows P groups 1 . . . N connected in series in accordance with an embodiment of the disclosure.

FIG. 3 illustrates a battery module during assembly after battery cells are inserted therein.

FIG. 4 illustrates a general arrangement of contact plate(s) with respect to battery cells of a battery module.

FIG. 5A illustrates an example of the layers of a conventional multi-layer contact plate.

FIG. 5B illustrates a multi-layer contact plate in accordance with an embodiment of the disclosure.

FIG. 5C illustrates a multi-layer contact plate in accordance with another embodiment of the disclosure.

FIG. 6 illustrates an exemplary manner by which cell terminal connections can be made between the coated or clad material contact plate and battery cell terminals in accordance with an embodiment of the disclosure.

FIGS. 7A-7B illustrate different contact plate arrangements in accordance with an embodiment of the disclosure.

FIG. 8 illustrates a bonding connector (or connection tap) that is integrated into a coated or clad material contact plate in accordance with an embodiment of the disclosure.

FIG. 9 illustrates a manufacturing process for a coated or clad material contact plate in accordance with an embodiment of the disclosure.

FIGS. 10A-10E illustrate examples of bonding connector (or connection tap) configurations in accordance with one or more embodiments of the disclosure. In particular, the bonding connector configurations in FIGS. 10A-10E illustrate bonding connectors (or connection tap) arranged with different combinations of joint areas, fuse areas and/or welding areas.

### DETAILED DESCRIPTION

Embodiments of the disclosure are provided in the following description and related drawings. Alternate embodiments may be devised without departing from the scope of the disclosure. Additionally, well-known elements of the disclosure will not be described in detail or will be omitted so as not to obscure the relevant details of the disclosure.

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

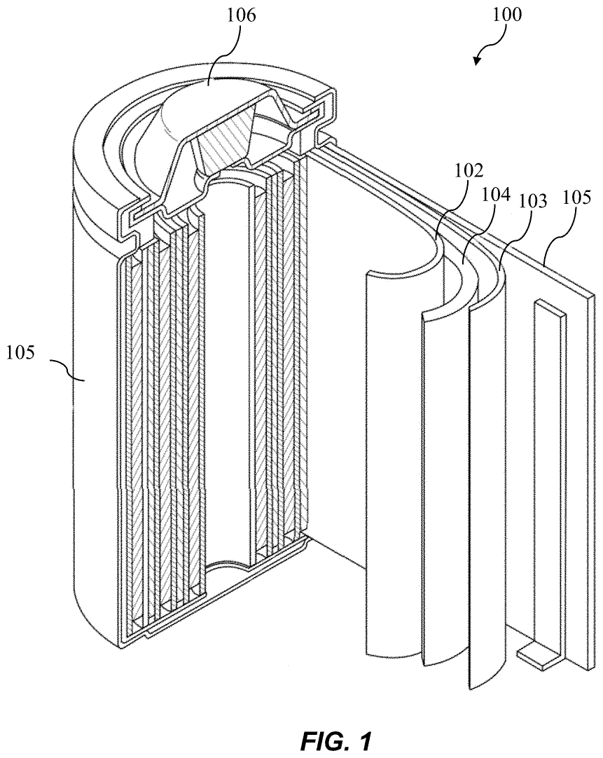

FIG. 1 illustrates an example metal-ion (e.g., Li-ion) battery in which the components, materials, methods, and other techniques described herein, or combinations thereof, may be applied according to various embodiments. A cylindrical battery cell is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105.

Embodiments of the disclosure relate to various configurations of battery modules that may be deployed as part of an energy storage system. In an example, while not illustrated expressly, multiple battery modules in accordance with any of the embodiments described herein may be deployed with respect to an energy storage system (e.g., chained in series to provide higher voltage to the energy storage system, connected in parallel to provide higher current to the energy storage system, or a combination thereof).

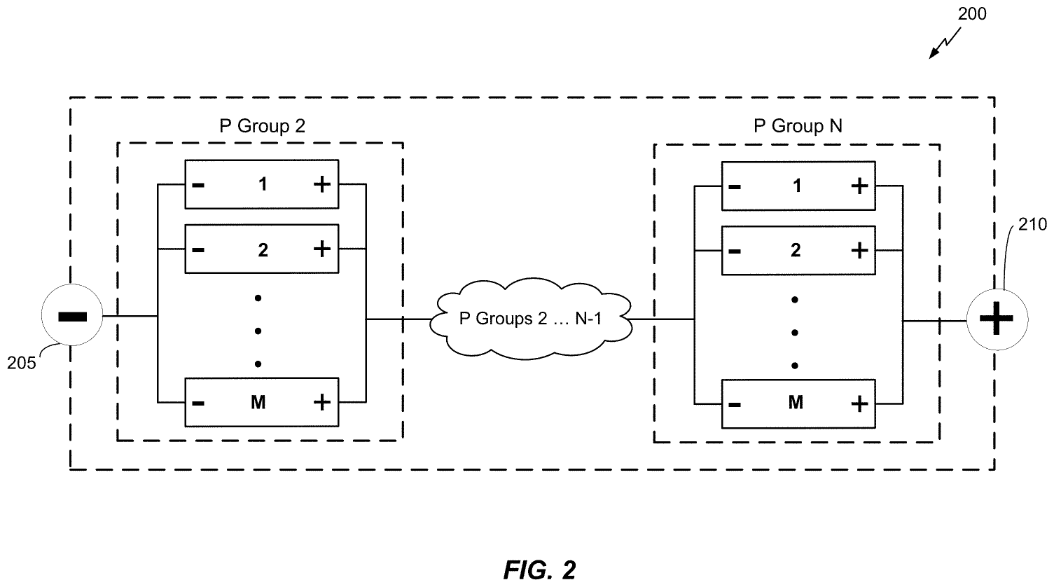

FIG. 2 illustrates a high-level electrical diagram of a battery module 200 that shows P groups 1 . . . N connected in series in accordance with an embodiment of the disclosure. In an example, N may be an integer greater than or equal to 2 (e.g., if N=2, then the intervening P groups denoted as P groups 2 . . . N−1 in FIG. 1 may be omitted). Each P group includes battery cells 1 . . . M (e.g., each configured as shown with respect to battery cell 100 of FIG. 1) connected in parallel. The negative terminal of the first series-connected P group (or P group 1) is coupled to a negative terminal 205 of the battery module 200, while the positive terminal of the last series-connected P group (or P group N) is connected to a positive terminal 210 of the battery module 200. As used herein, battery modules may be characterized by the number of P groups connected in series included therein. In particular, a battery module with 2 series-connected P groups is referred to as a “2S” system, a battery module with 3 series-connected P groups is referred to as a “3S” system, and so on.

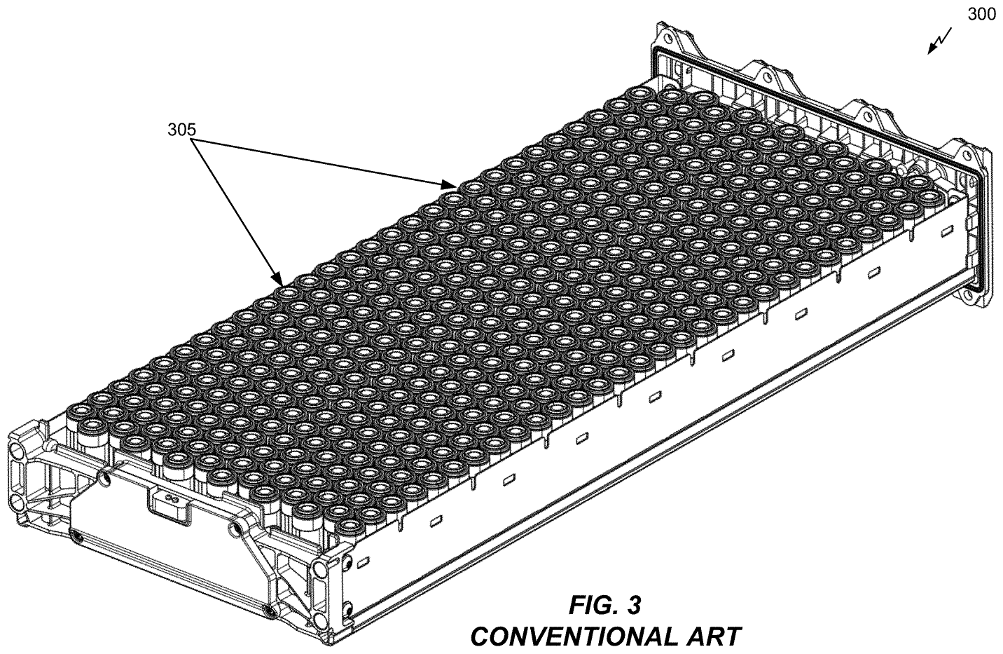

FIG. 3 illustrates a battery module 300 during assembly after battery cells 305 are inserted therein. In some designs, both the positive terminal (cathode) and negative terminal (anode) of the battery cells in the battery module 300 may be arranged on the same side (e.g., the top side). For example, the centered cell ‘head’ may correspond to the positive terminal, while the outer cell rim that rings the cell head may correspond to the negative terminal. In such a battery module, the P groups are electrically connected in series with each other via a plurality of contact plates arranged on top of the battery cells 305.

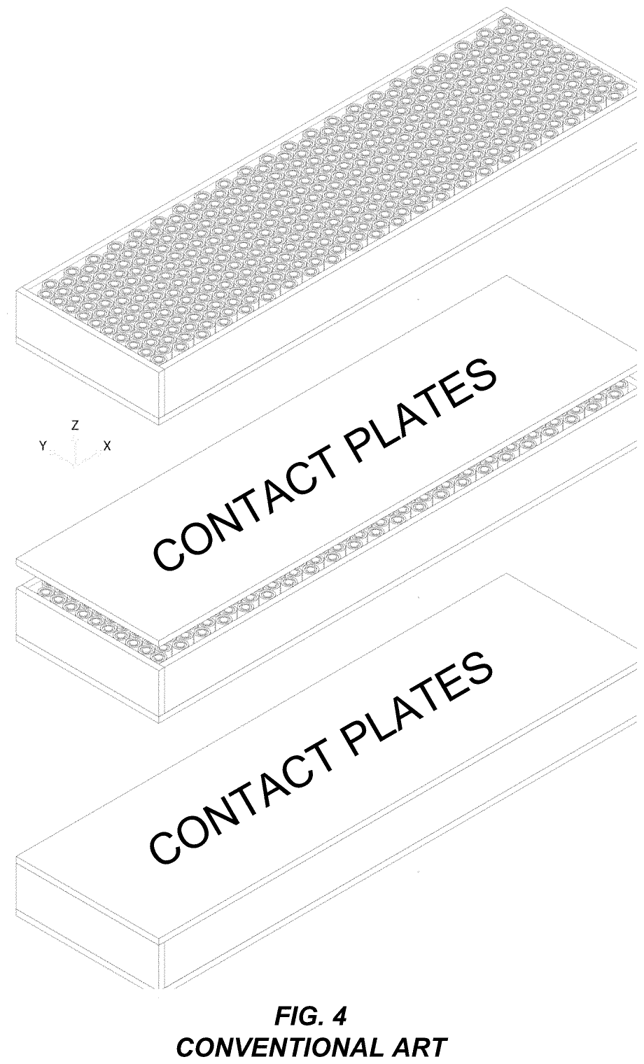

FIG. 4 illustrates the general arrangement of contact plate(s) with respect to battery cells of a battery module. As shown in FIG. 4, the contact plates may be arranged on top of the battery cells in close proximity to their respective positive and negative terminals in some designs.

There are a variety of ways in which the above-noted contact plates may be configured. For example, the contact plates can be configured as solid blocks of aluminum or copper, whereby bonding connectors are spot-welded between the contact plates and the positive and negative terminals of the battery cells. Alternatively, a multi-layer contact plate that includes an integrated cell terminal connection layer may be used.

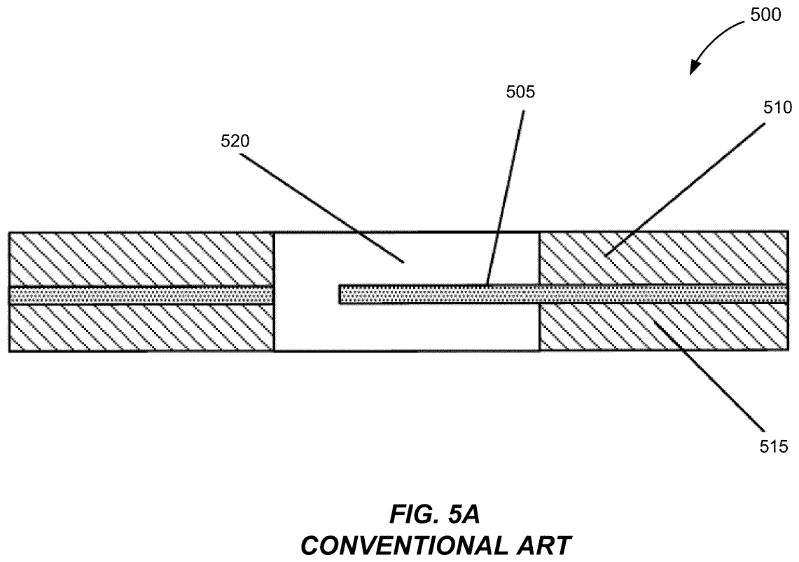

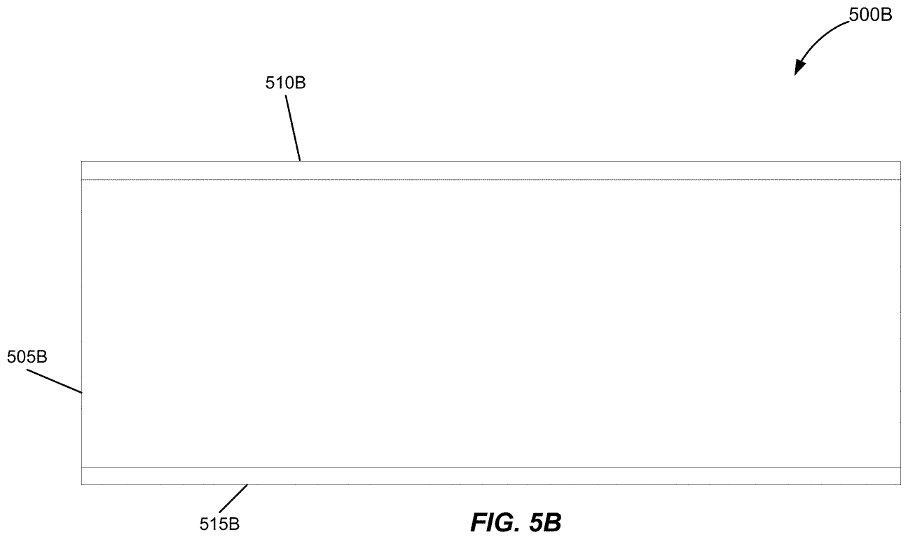

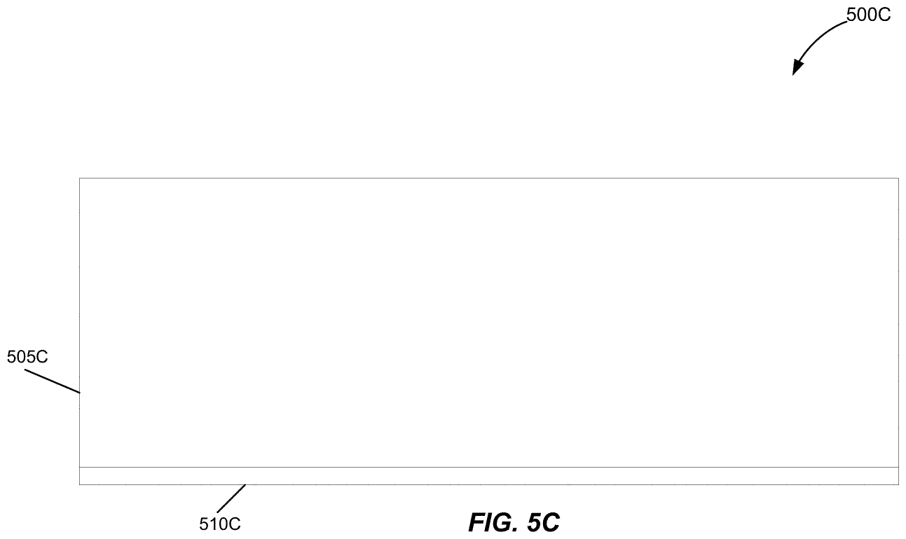

FIG. 5A illustrates an example of the layers of a conventional multi-layer contact plate 500. In FIG. 5A, the multi-layer contact plate 500 includes a flexible cell terminal connection layer 505 that is sandwiched between a top conductive plate 510 and a bottom conductive plate 515. In an example, the top and bottom conductive plates 510 and 515 may be configured as solid Cu or Al plates (e.g., or an alloy of Cu or Al), while the flexible cell terminal connection layer 505 is configured as foil (e.g., steel or Hilumin foil). A number of holes, such as hole 520, are punched into the top and bottom conductive plates 510 and 515, while some part of the flexible cell terminal connection layer 505 extends or protrudes out into the hole 520. During battery module assembly, the part of the flexible cell terminal connection layer 505 that extends into the hole 520 can then be pressed downward so as to contact a positive or negative terminal of one or more battery cells arranged underneath the hole 520, and then welded to obtain a mechanically stable plate-to-terminal electrical connection.

Referring to FIG. 5A, the layers of the multi-layer contact plate 500 may be joined via soldering or brazing (e.g., based on soldering or brazing paste being arranged between the respective layers before heat is applied), which results in soldering or brazing “joints” between the respective layers. These joints provide both (i) an inter-layer mechanical connection for the multi-layer contact plate 500, and (ii) an inter-layer electrical connection for the multi-layer contact plate 500.

Referring to FIG. 5A, one of the advantages of configuring the flexible cell terminal connection layer 505 with a different material (e.g., steel or Hilumin) than the surrounding top and bottom conductive plates 510 and 515 (e.g., Cu, Al, or an alloy thereof) is so that the cell terminal connections can be welded via like metals. For example, it is common for cell terminals to be made from steel or Hilumin. However, steel is not a particularly good conductor. Hence, the top and bottom conductive plates 510 and 515 are made from a more conductive material (e.g., Cu, Al, or an alloy thereof) than steel, while steel is used in the flexible cell terminal connection layer 505 to avoid disparate metals being welded together for the cell terminal connection.

One or more embodiments of the present disclosure are directed to a clad or ‘coated’ plate structure that obtains some of the above-noted benefits of the multi-layer contact plate 500 of FIG. 5A while being much simpler to produce (especially at scale). Instead of two solid plates sandwiching a foil terminal connection layer, one or more embodiments are directed to a contact plate (e.g., Cu, Al, or an alloy thereof, although it is possible for the contact plate to be multi-layer) that is coated with a thin layer of a different metal (e.g., steel or Hilumin) that is suitable to be welded to one or more battery cell terminals. The coated contact plate can be locally punched or etched to define specific sections that (i) can be moved flexible, or (ii) can be configured as a fuse, or (iii) can be made suitable for welding to the battery cell terminal(s).

FIG. 5B illustrates a coated or clad material contact plate 500B in accordance with an embodiment of the disclosure. In an example, the coated (or clad material) contact plate 500B may include a conductive plate 505B (e.g., Cu, Al, or an alloy thereof) with an average thickness in the range from about 0.3 mm to about 3.0 mm (e.g., preferably, in the range from about 1.0 mm to about 2.0 mm) and a coating or cladding on the conductive plate with an average thickness in the range from about 0.05 mm to about 1.00 mm (e.g., preferably, in the range from about 0.15 mm to about 0.45 mm). In particular, the contact plate 500B may be coated or cladded with a first metallic surface layer 510B (e.g., steel or Hilumin) on one side of the conductive plate 505B, and may further be may be coated or cladded with a second metallic surface layer 515B on one side of the conductive plate 505B. In some designs, the first and second metallic surface layers 510B-515B may comprise the same metal (e.g., steel or Hilumin), while in other designs the first and second metallic surface layer 510B-515B may comprise the different metals. In some designs, the first and second metallic surface layers 510B-515B for thermal compensation. For example, when two different metals are joined together, each respective metal generally has a different thermal expansion coefficient, which causes these metals to bend in response to changing temperature. However, if the first and second metallic surface layers 510B-515B comprise the same metal, each respective metallic surface layer's thermal expansion will cancel out the other's, thereby producing a more stable (and even) contact plate 500B during operation. Relative to the multi-layer contact plate 500 of FIG. 5A, the coated/cladded contact plate 505B may be produced via a simple and robust coil-to-part punching process in some designs. In some designs, the contact plate 500B of FIG. 5B may be characterized as a multi-layer contact plate with three layers (e.g., a conductive plate layer, a top coated/cladded metallic surface layer, and a bottom coated/cladded metallic surface layer).

FIG. 5C illustrates a coated or clad material contact plate 500C in accordance with another embodiment of the disclosure. Referring to FIG. 5C, in an alternative example, only one side of a conductive plate 505C may be coated or cladded with a metallic surface layer 510C. For example, one particular side of the contact plate 500C may be welded or otherwise adhered directly to cell terminals of the battery cells. In some designs, only this contacting side of the contact plate 500C may be coated/cladded with a metallic surface layer (e.g., such that some part of this metallic surface layer is the component of the bonding connector that forms the direct plate-to-terminal contact). In some applications, the two-layer contact plate design in FIG. 5C may be simpler and cheaper to produce relative to the three-layer contact plate FIG. 5B, but may also suffer more from bi-metal thermal expansion effects during operation.

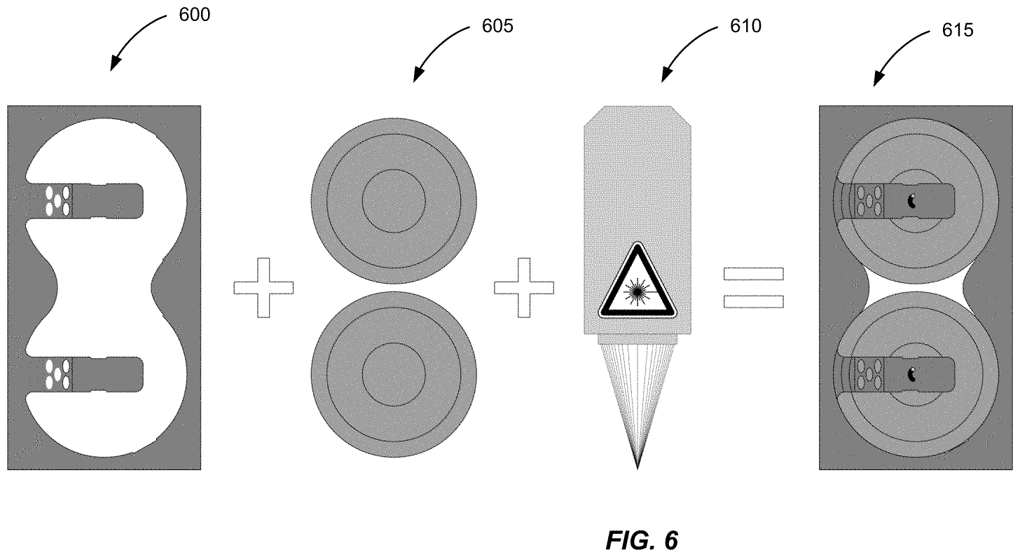

FIG. 6 illustrates an exemplary manner by which cell terminal connections can be made between a coated or clad material contact plate (e.g., contact plate 505B of FIG. 5B or contact plate 505C of FIG. 5C) and battery cell terminals in accordance with an embodiment of the disclosure. The example of FIG. 6 depicts cell terminal connections being formed between two bonding connectors (formed from part of a coated or clad material contact plate) to two respective positive cell heads. In particular, a coated or clad material contact plate (a portion of which is shown at 600) is arranged over battery cells (such as battery cells 605, among others) and then welded (e.g., laser welded, as shown at 610), with a result of the welding shown at 615.

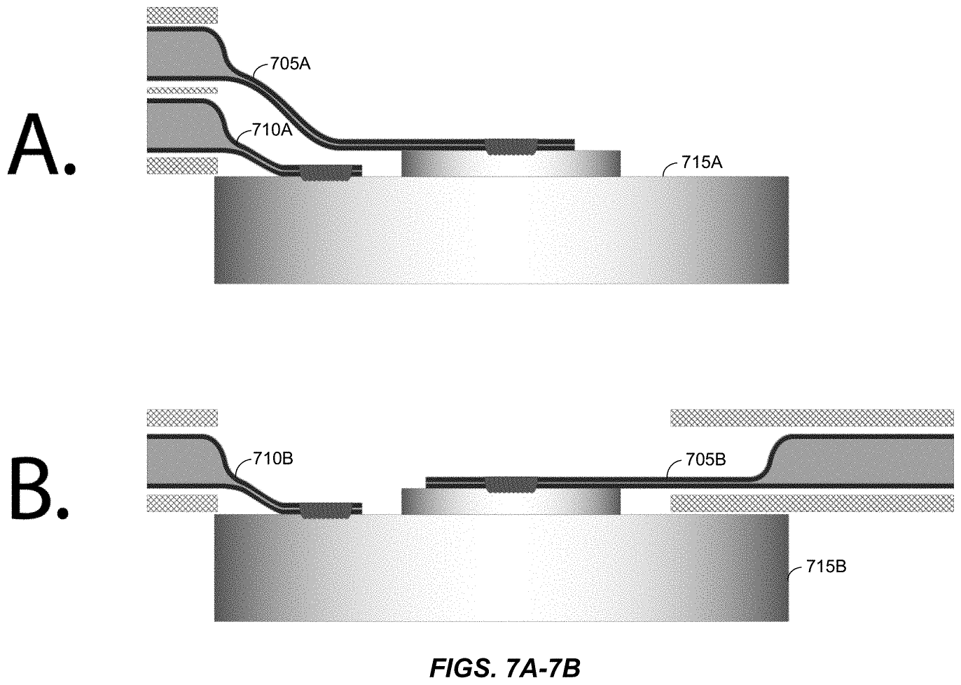

FIGS. 7A-7B illustrate different contact plate arrangements in accordance with an embodiment of the disclosure.

Referring to FIG. 7A, a “double-decker” (or two-layer) contact plate configuration is shown, whereby two different contact plates 705A and 710A are vertically stacked on top of each other. The top-mounted contact plate 705A is electrically connected to a positive cell head of battery cell 715A, while the bottom-mounted contact plate 710A is electrically connected to a negative cell rim of battery cell 715A. Each of the contact plates 705A and 710A may be arranged as a coated or clad material contact plate in some designs.

Referring to FIG. 7B, a “single-decker” (or single-layer) contact plate configuration is shown, whereby two different contact plates 705B and 710B are not vertically stacked. The contact plate 705B is electrically connected to a positive cell head of battery cell 715B, while the contact plate 710B is electrically connected to a negative cell rim of battery cell 715B. Each of the contact plates 705B and 710B may be arranged as a coated or clad material contact plate in some designs.

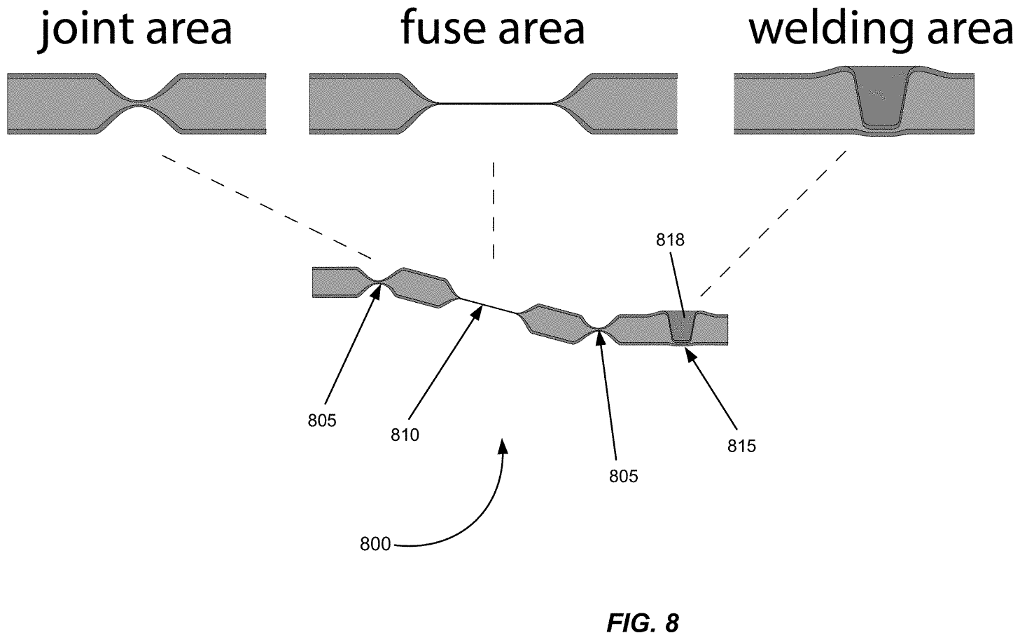

FIG. 8 illustrates a bonding connector 800 (or connection tap) that is integrated into a coated or clad material contact plate in accordance with an embodiment of the disclosure. Generally, specific sections of the coated contact plate are etched, pressed or crimped to produce flexible joint areas 805, a fuse area 810 and a welding area 815. The flexible joint areas permit the bonding connector 800 to be flexibly arranged (e.g., pressed downward against one or more battery cell terminals), the fuse area 810 is configured to break at a particular temperature or current threshold (e.g., an overload condition, which may occur in millisecond(s) if the temperature or current is very high or may occur over a longer period of time, such as several seconds, if the temperature or current is only moderately high; in some designs, a fuse with a 25 Amp fuse rating may be used for a 21700 battery cell) during battery cell operation before any other part of the bonding connector 800 (and may also contribute to the flexibility of the bonding connector 800) and the welding area 815 may be configured to be suitable for welding to the battery cell terminal(s). For example, the welding area 815 may comprise a depressed region 818. For example, welding through the full thickness of the welding area 815 of the bonding connector 800 (or connection tap) may be difficult. Configuring the welding area 815 with a thinner region (i.e., depressed region 818) may facilitate the welding to the cell terminal. In some designs, the depressed region 818 may be arranged as a cavity of the welding area 815 which is partially or fully filed with a welding or brazing material. In a specific example, a thickness of a cell can of a battery cell may be about 0.3 mm, and a total thickness (except in the depressed region 818) of the welding area 815 may be about 0.2 mm. It may be difficult to weld these parts together (e.g., comprised of Hilumin in some designs). For example, a maximum welding ratio of an upper sheet metal part to a lower sheet metal part may be defined at about 2:1 to avoid a break in a welding seam in the lower sheet metal part. By thinning the welding area 815 in the depressed region 818, the depressed region 818 can satisfy the maximum welding ratio. Hence, the depressed region 818 of the welding area 815 be welded to a corresponding cell terminal without breaking the welding seam with the cell terminal. In some designs, avoiding breaks in the welding seam is particularly important for minus pole cell terminal connections so as to prevent damage to a seal of the battery cell.

In some designs, the fuse area 810 may not only be thinned out in terms of thickness as shown in FIG. 8, but may also have one or more sections tapered and/or cut out to achieve a desired fuse rating (e.g., such that current density across the fuse area 810 is increased during battery operation so that any break will occur first at the fuse area 810). In some designs, the fuse area 810 may be thinned out in terms of width as well, either in place of or in addition to the thinning out of the fuse area 810 in terms of thickness as shown in FIG. 8.

Referring to FIG. 8, in some designs, the fuse area 810 may be controlled so as to achieve a target fuse rating (e.g., a target current threshold at which the fuse area 810 is designed to break). In some designs, one or more bonding connectors in a coated or clad material contact plate may be arranged with a fuse area 810 having a higher fuse rating than any other bonding connector of the coated or clad material contact plate so as to control where the last bonding connector of the coated or clad material contact plate to break will be located (e.g., because the last bonding connector to break is the most likely location for an electrical ‘arc’ to occur). Various arc protective mechanisms can then be arranged to mitigate such arcs at that ‘high-fuse’ bonding connector (e.g., which is less expensive and less complex than implementing such arc protective mechanisms at all bonding connectors of the coated or clad material contact plate).

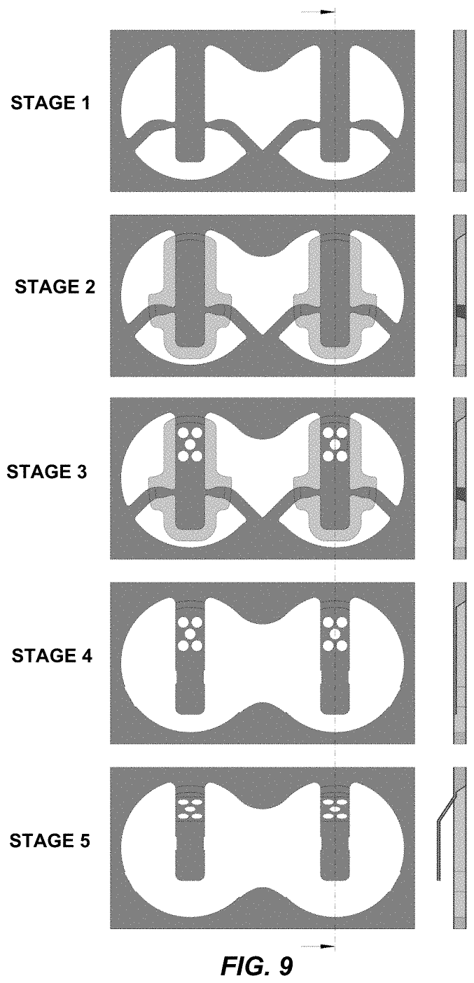

FIG. 9 illustrates a manufacturing process for a coated or clad material contact plate in accordance with an embodiment of the disclosure. Assume that a solid contact plate (e.g., Cu, Al, or an alloy thereof) is coated/cladded with a different metal (e.g., steel or Hilumin) to produce a solid block coated/cladded contact plate. At Stage 1, the coated/cladded contact plate is punched in a desired pattern, for example, to define the general shape of the bonding connector at respective contact areas for the cell terminal connections. At Stage 2, the bonding connector is depressed (primarily with respect to the core or inner conductive plate layer, without much impact to the coating) to a desired level. The depression (or thinning) of the bonding connector at Stage 2 may be connector-wide or very localized (e.g., to define the various joints, fuse area and welding area of the bonding connector). At Stage 3, sections of the fuse area are punched out (e.g., as holes). At Stage 4, excess material from the bonding connector as a result of the depression at Stage 2 is removed (e.g., cut off). At Stage 5, the bonding connector is reconfigured into a desired shape (e.g., pressed downward, etc.).

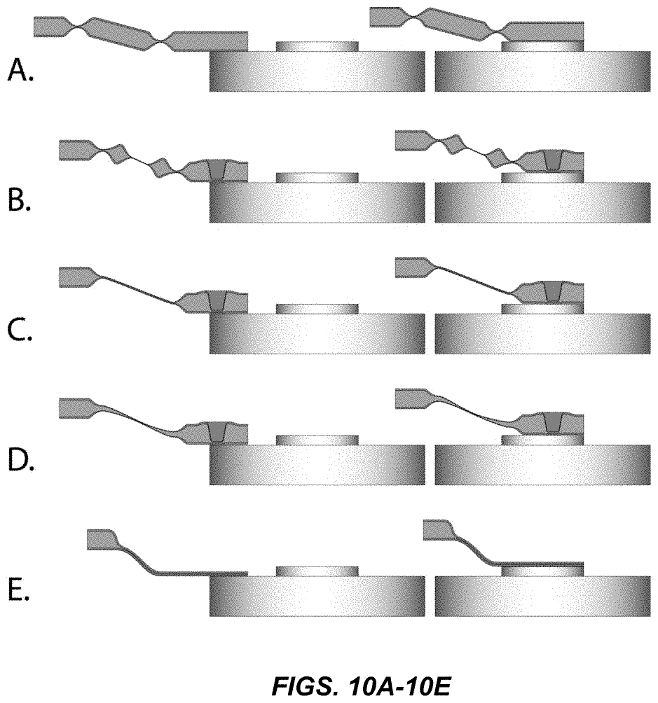

FIGS. 10A-10E illustrate examples of bonding connector configurations in accordance with one or more embodiments of the disclosure. In particular, the bonding connector configurations in FIGS. 10A-10E illustrate bonding connectors arranged with different combinations of joint areas, fuse areas and/or welding areas.

Referring to FIG. 10A, a negative cell terminal bonding connector (left side) and a positive cell terminal bonding connector (right side) are each configured with two joint areas. These two joint areas make the respective bonding connectors sufficiently flexible to be lowered (e.g., pressed downward) against a corresponding cell terminal (e.g., and then ultrasonically welded or soldered to the cell terminal, or alternatively laser welded if a welding area of the bonding connector that contacts the respective cell terminal is arranged with a lower thickness according to the maximum welding ratio as noted above).

Referring to FIG. 10B, a negative cell terminal bonding connector (left side) and a positive cell terminal bonding connector (right side) are each configured with two joint areas, a fuse area and a welding area for laser welding.

Referring to FIG. 10C, a negative cell terminal bonding connector (left side) and a positive cell terminal bonding connector (right side) are each configured with a flattened flexible area and a welding area for laser welding. The flattened flexible area is essentially a wider version of the joint areas described above. In some designs, the flattened flexible area may provide dual functionality in terms of acting as both a joint area as well as a fuse area.

Referring to FIG. 10D, a negative cell terminal bonding connector (left side) and a positive cell terminal bonding connector (right side) are each configured with a flattened flexible area that further functions as a fuse area and a welding area for laser welding. In some designs, the flattened flexible area of FIG. 10D may have a varying thickness, in contrast to the flattened flexible area of FIGS. 10C and 10E which each have a substantially uniform thickness. In an example, the flattened flexible area of FIG. 10D may vary in thickness to more specifically control where the flattened flexible area will break (or ignite) in response to a fuse event. In particular, the narrowest or thinnest part of the flattened flexible area of FIG. 10D will generally be expected to break first in this manner.

Referring to FIG. 10E, a negative cell terminal bonding connector (left side) and a positive cell terminal bonding connector (right side) are each configured with an extended flattened flexible area having an integrated fuse (e.g., based on the flattening or further based on material being punched out or otherwise removed from a particular area of the bonding connector). The section of the bonding connector that contacts a corresponding cell terminal may be laser welded, soldered or laser-soldered thereto.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range.

The forgoing description is provided to enable any person skilled in the art to make or use embodiments of the invention. It will be appreciated, however, that the invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the embodiments of the invention.

What is claimed is:

1. A battery module, comprising:
a plurality of battery cells that each include a cell terminal formed from a first metal; and
a contact plate including a conductive plate that is formed from a second metal and a first metallic surface layer arranged on a first side of the conductive plate that is formed from the first metal,
wherein part of the contact plate is arranged as a plurality of bonding connectors that form direct electrical connections to the cell terminals of the plurality of battery cells.

2. The battery module of claim 1, wherein part of the first metallic surface layer is in direct contact with the cell terminals.

3. The battery module of claim 1, further comprising:
a second metallic surface layer arranged on a second side of the conductive plate that is formed from the first metal.

4. The battery module of claim 1, wherein the first metal comprises steel, coated steel or Hilumin.

5. The battery module of claim 1, wherein the second metal comprises Cu, Al or an alloy thereof.

6. The battery module of claim 1, further comprising:
another contact plate that includes a bonding connector that forms a direct electrical connection to a cell terminal of one of the plurality of battery cells.

7. The battery module of claim 6, wherein the contact plate and the another contact plate are stacked on top of each other above the cell terminal.

8. The battery module of claim 6, wherein the contact plate and the another contact plate are not stacked on top of each other above the cell terminal.

9. The battery module of claim 1, wherein at least one of the plurality of bonding connectors comprises a fuse area that is configured to break before any other part of the respective bonding connector in response to a temperature of the respective bonding connector exceeding a particular temperature threshold or a current flowing through the respective bonding connector exceeding a particular current threshold.

10. The battery module of claim 9,
wherein the fuse area is thinner than any other part of the respective bonding connector in terms of thickness and/or width, or
wherein the fuse area includes one or more tapered or cutout sections, or
any combination thereof.

11. The battery module of claim 1, wherein at least one of the plurality of bonding connectors comprises at least one joint area where the at least one bonding connector is configured to permit flexing.

12. The battery module of claim 11, wherein the at least one bonding connector includes a single joint area.

13. The battery module of claim 11, wherein the at least one bonding connector includes multiple joint areas that are separate from each other.

14. The battery module of claim 11, wherein the at least one joint area corresponds to a respective depressed or crimped section of the at least one bonding connector.

15. The battery module of claim 1, wherein at least one of the plurality of bonding connectors comprises at a welding area where a respective direct electrical connection is formed with a respective cell terminal.

16. The battery module of claim 1, wherein an average thickness of the conductive plate is in the range from about 0.3 mm to about 3.0 mm.

17. The battery module of claim 16, wherein an average thickness of the conductive plate is in the range from about 1.0 mm to about 2.0 mm.

18. The battery module of claim 1, wherein an average thickness of the first metallic surface layer is in the range from about 0.05 mm to about 1.00 mm.

19. The battery module of claim 18, wherein the average thickness of the first metallic surface layer is in the range from about 0.15 mm to about 0.45 mm.

20. The battery module of claim 1, wherein at least one of the plurality of bonding connectors is at least partially formed and/or depressed in thickness and/or width.

21. The battery module of claim 1, wherein the first metallic surface layer is cladded on the conductive plate.

22. The battery module of claim 1, wherein the first metallic surface layer is coated on the conductive plate.

23. A battery module, comprising:
a plurality of battery cells that each include a cell terminal formed from a first metal; and
a contact plate including a conductive plate that is formed from a second metal, a first metallic surface layer arranged on a first side of the conductive plate that is formed from the first metal, and a second metallic surface layer arranged on a second side of the conductive plate,
wherein part of the contact plate is arranged as a plurality of bonding connectors that form direct electrical connections to the cell terminals of the plurality of battery cells.

24. The battery module of claim 23, the second metallic surface layer is also formed from the first metal so as to compensate for thermal expansion of the first metallic surface layer.

25. The battery module of claim 23, wherein part of either the first metallic surface layer or the second metallic surface layer is in direct contact with the cell terminals.

26. The battery module of claim 23, wherein the first metal comprises steel, coated steel or Hilumin.

27. The battery module of claim 23, wherein the second metal comprises Cu, Al or an alloy thereof.

28. The battery module of claim 23, wherein at least one of the plurality of bonding connectors comprises a fuse area that is configured to break before any other part of the respective bonding connector in response to a temperature of the respective bonding connector exceeding a particular temperature threshold or a current flowing through the respective bonding connector exceeding a particular current threshold.

29. The battery module of claim 23, wherein at least one of the plurality of bonding connectors comprises at least one joint area where the at least one bonding connector is configured to permit flexing.

30. The battery module of claim 23, wherein at least one of the plurality of bonding connectors comprises at a welding area where a respective direct electrical connection is formed with a respective cell terminal.
